(19) United States
(12) Patent Application Publication
(10) Pub. No.: US 2005/0173887 A1
(43) Pub. Date: Aug. 11, 2005

(54) Four-link connecting device for connecting a trailer to a bicycle

(76) Inventor: Johnny Chen, Hsien (TW)

Correspondence Address: HARNESS, DICKEY & PIERCE, P.L.C., P.O. BOX 8910, RESTON, VA, 20195, US

(21) Appl. No.: 10/775,071

(22) Filed: Feb. 11, 2004

(51) Int. Cl. B62K 27/00

(52) U.S. Cl. 280/204

(57) ABSTRACT

A four-link connecting device for connecting a trailer to a bicycle includes left and right links, and front and rear links, each of which has left and right ends connected respectively and pivotally to the left and right links. The left and right links are connected swingably to the bicycle. A rear connecting member is connected pivotally to one of the front and rear links, and is connected fixedly to a frame of the trailer. The distance between left end pivots of the front and rear links is equal to that between right end pivots of the front and rear links, and the distance between the left and right end pivots of the front link is equal to that between the left and right end pivots of the rear link.

### BACKGROUND OF THE INVENTION

1. Field of the Invention

This invention relates to a connecting device for connecting a trailer to a bicycle, and more particularly to a four-link connecting device for connecting a trailer to a bicycle, which includes front, rear, left, and right links.

2. Description of the Related Art

Referring to FIGS. 1 and 2, a conventional connecting device 3 for connecting a trailer 2 to a bicycle 1 is shown to include a pair of left and right links 31, a pair of left and right connecting members 32, a U-shaped rear link 33, and a rear coupling member 34. The left and right links 31 are connected respectively and detachably to rear fork rods 11 of the bicycle 1 by the left and right connecting members 32 so as to permit frontward and rearward swinging movement of the left and right links 31 relative to the rear fork rods 11 of the bicycle 1. The rear coupling member 34 is connected fixedly to a frame of the trailer 2. The rear link 33 is formed integrally with rear ends of the left and right links 31, and is connected rotatably to the rear coupling member 34 by a vertical pivot pin (A). Because the rear link 33 is fixed relative to the left and right links 31, and due to an adverse effect of inertia of the trailer 2, the bicycle 1 cannot be steered smoothly thereby resulting in excessive swinging movement and even turnover of the bicycle 1.

### SUMMARY OF THE INVENTION

It is the object of this invention to provide a four-link connecting device for connecting a trailer to a bicycle, which can facilitate smooth steering movement of the bicycle.

According to this invention, a four-link connecting device for connecting a trailer to a bicycle includes left and right links, and front and rear links, each of which has left and right ends connected respectively and pivotally to the left and right links. The left and right links are connected swingably to the bicycle. A rear connecting member is connected pivotally to one of the front and rear links, and is connected fixedly to a frame of the trailer. The distance between left end pivots of the front and rear links is equal to that between right end pivots of the front and rear links, and the distance between the left and right end pivots of the front link is equal to that between the left and right end pivots of the rear link so as to permit synchronous movement of the front and rear links and of the left and right links, thereby facilitating smooth steering movement of the bicycle.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a side view of an assembly of a bicycle and a trailer that are interconnected by a conventional connecting device;

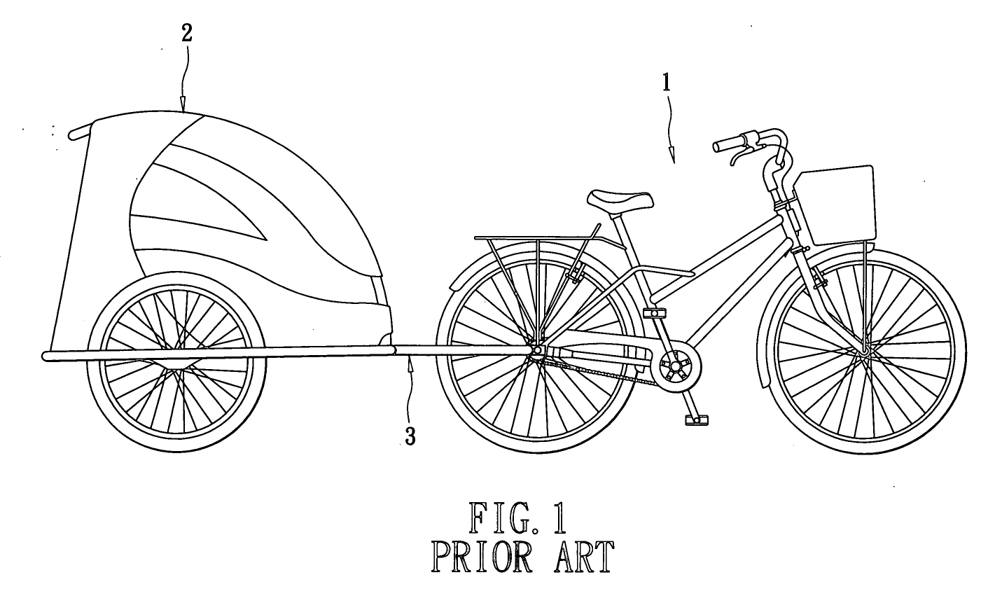

FIG. 2 is a schematic top view of the conventional connecting device;

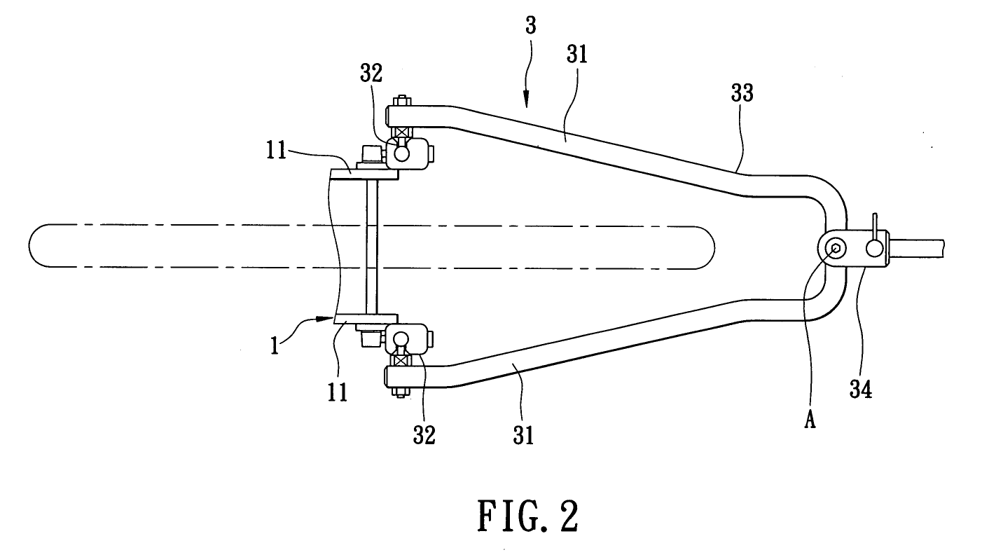

FIG. 3 is a schematic, partly exploded top view of the preferred embodiment of a four-link connecting device for connecting a trailer to a bicycle according to this invention;

FIG. 4 is a schematic assembled top view of the preferred embodiment;

FIG. 5 is a schematic assembled top view of the preferred embodiment, illustrating the position of the trailer relative to the bicycle when the bicycle is being turned to the left; and

FIG. 6 is a schematic assembled top view of the preferred embodiment, illustrating the position of the trailer relative to the bicycle when the bicycle is being turned to the right.

### DETAILED DESCRIPTION OF THE PREFERRED EMBODIMENT

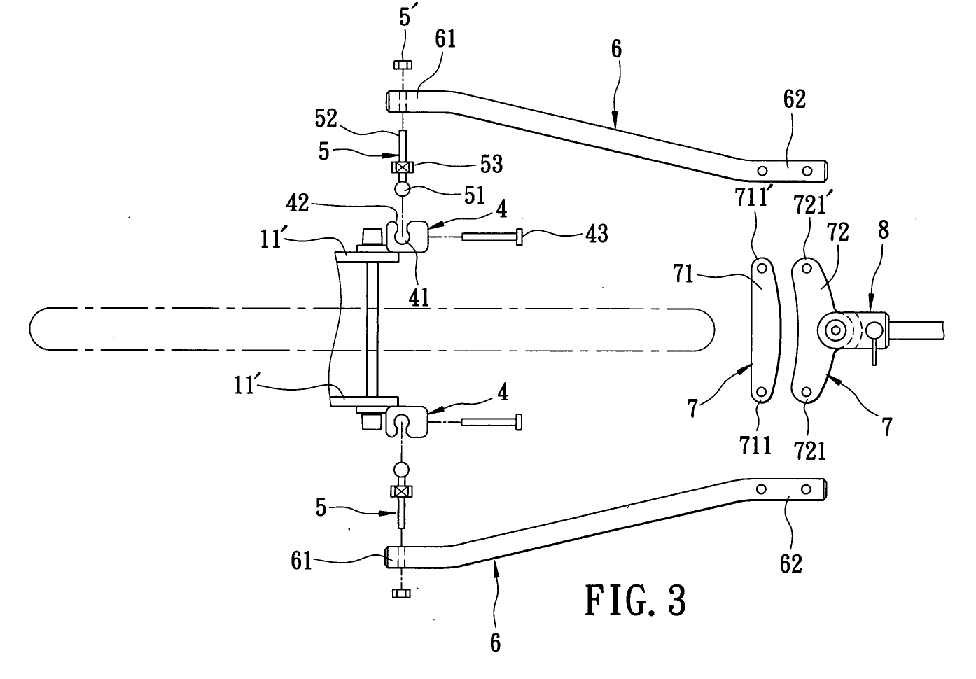

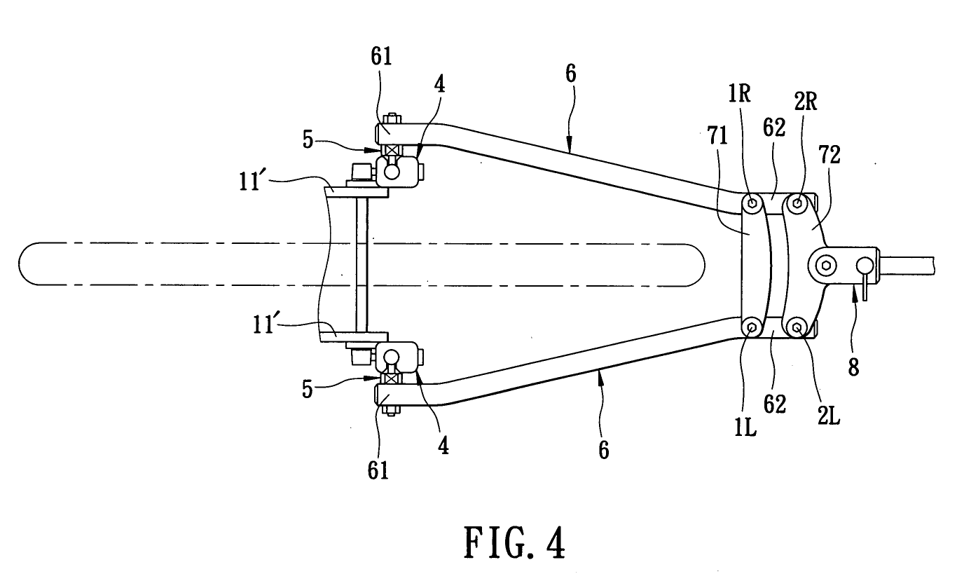

Referring to FIGS. 3 and 4, the preferred embodiment of a four-link connecting device according to this invention is adapted for connecting a trailer (not shown) to a pair of left and right rear fork rods 11′ of a bicycle (not shown), and is shown to include a pair of left and right connecting members each having a connecting seat 4 and a threaded rod 5, a pair of left and right links 6, a front link, a rear link, and a rear connecting member 8.

The left and right links 6 are connected respectively to the left and right rear fork rods 11′ of the bicycle in a known manner. The connecting seats 4 are connected respectively and fixedly to the left and right rear fork rods 11′ of the bicycle. Each of the connecting seats 4 is formed with a vertical dovetail groove 41 that has a closed upper end (not shown), an open lower end, and a diverging side opening 42. The threaded rods 5 are connected respectively and fixedly to front ends 61 of the left and right links 6 by lock nuts 5′. Each of threaded rods 5 has an enlarged rounded inner end 51 received rotatably within the dovetail groove 41 in the corresponding connecting seat 4, and a threaded outer end 52 that extends through the front end 61 of a corresponding one of the left and right links 6. Each of the front ends 61 of the left and right links 6 is clamped between the corresponding lock nut 5′ and an annular projection 53 of the corresponding threaded rod 5 so as to connect the threaded rods 5 respectively and fixedly to the left and right links 6. Two bolts 43 extend respectively through the connecting seats 4, and are disposed immediately under the rounded ends 51 of the threaded rods 5 so as to prevent downward removal of the rounded ends 51 of the threaded rods 5 from the dovetail grooves 41 in the connecting seats 4. As such, the left and right links 6 can swing frontwardly and rearwardly relative to the bicycle. The bolts 43 can be removed from the connecting seats 4 so as to permit separation of the left and right links 6 from the left and right rear fork rods 11′ of the bicycle.

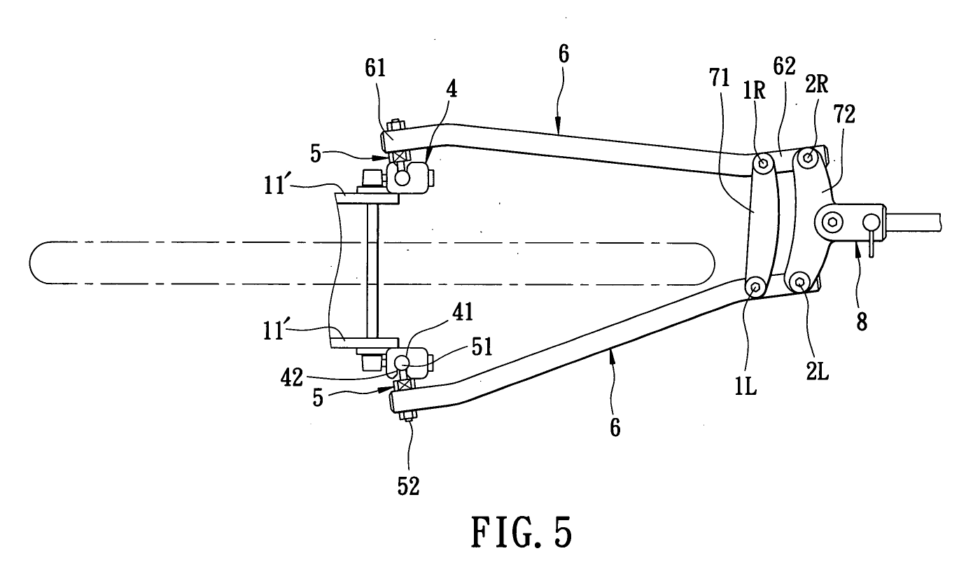

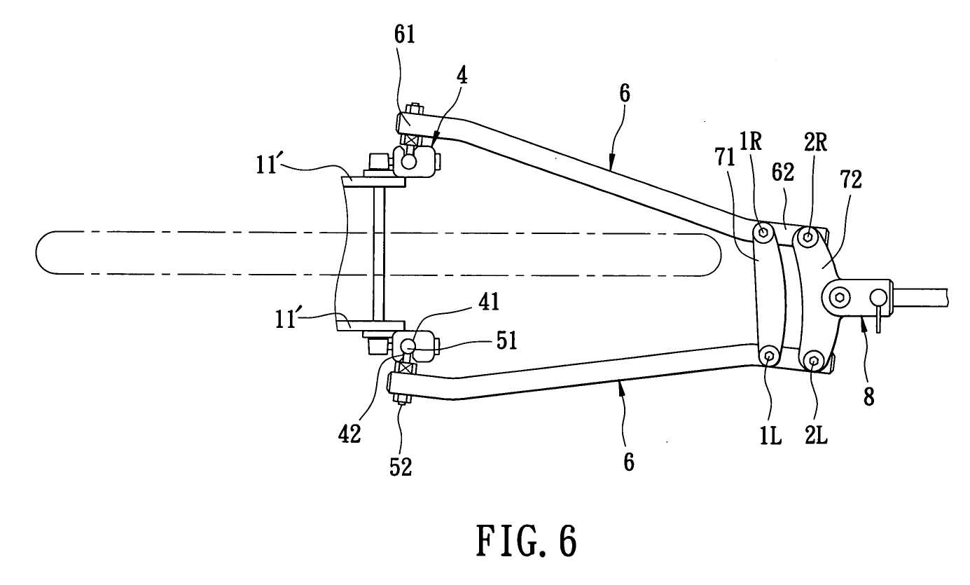

The rear link includes a link body 72 having left and right ends 721, 721′, and vertical left and right end pivots (2L, 2R) for connecting the left and right ends 721, 721′ of the link body 72 respectively and rotatably to rear ends 62 of the left and right links 6. The front link includes a link body 71 having left and right ends 711, 711′, and vertical left and right end pivots (1L, 1R) respectively and rotatably to intermediate portions of the left and right links 6. The rear coupling member 8 is connected pivotally to a middle portion of the rear link, and is connected fixedly to a frame of the trailer (not shown). Alternatively, the rear coupling member 8 may be connected pivotally to a middle portion of the front link. The distance between the left end pivots (1L, 2L) of the front and rear links is equal to that between the right end pivots (1R, 2R) of the front and rear links. The distance between the left and right end pivots (1L, 1R) of the front link is equal to that between the left and right end pivots (2L, 2R) of the rear link so as to permit synchronous movement of the front and rear links and of the left and right links 6, as shown in FIGS. 5 and 6, thereby resulting in a reduction in the inertia effect of the trailer, which in turn facilitates smooth steering movement of the bicycle.

With this invention thus explained, it is apparent that numerous modifications and variations can be made without departing from the scope and spirit of this invention. It is therefore intended that this invention be limited only as indicated by the appended claims.

1. A four-link connecting device for connecting a frame of a trailer to a pair of left and right rear fork rods of a bicycle, said connecting device comprising:
a pair of left and right links, each of which has a front end and a rear end;
a left connecting member adapted to connect said front end of said left link detachably to the left rear fork rod of the bicycle such that said left link can swing forwardly and rearwardly relative to the left rear fork rod of the bicycle;
a right connecting member adapted to connect said front end of said right link detachably to the right rear fork rod of the bicycle such that said right link can swing forwardly and rearwardly relative to the right rear fork rod of the bicycle;
a rear link including a link body having left and right ends, and vertical left and right end pivots for connecting said left and right ends of said link body of said rear link respectively and rotatably to said rear ends of said left and right links;
a front link including a link body having left and right ends, and vertical left and right end pivots for connecting said left and right ends of said link body of said front link respectively and rotatably to intermediate portions of said left and right links, a distance between said left end pivots of said front and rear links being equal to that between said right end pivots of said front and rear links, a distance between said left and right end pivots of said front link being equal to that between said left and right end pivots of said rear link so as to permit synchronous movement of said front and rear links and of said left and right links; and
a rear coupling member connected pivotally to one of said front and rear links and adapted to be connected fixedly to the frame of the trailer.
